(19) United States
(12) Patent Application Publication
(10) Pub. No.: US 2011/0260862 A1
(43) Pub. Date: Oct. 27, 2011

(54) MONITORING METHOD FOR SECURITY SYSTEM

(76) Inventor: Fu-Cheng PAN, Taipei City (TW)

(21) Appl. No.: 12/984,684

(22) Filed: Jan. 5, 2011

(30) Foreign Application Priority Data
Apr. 27, 2010 (TW) 099113253

(51) Int. Cl. G08B 1/08

(52) U.S. Cl. 340/539.22

(57) ABSTRACT

A monitoring method for a security system is disclosed. The security system mainly comprises a remote communication device, a local communication device, a main controller and a main sensor or a plurality of main sensors. Each main sensor detects the status of a monitoring location, and sends sending an output signal to the main controller when each main sensor is triggered. The main controller collects output signals sent by each main sensor, and transmits the collected output signals to the local communication device. The local communication device and remote communication device establish a link via a communication connection to transform the received output signals into a warning message to return to the remote communication device whereby a user is informed of the status occurred in a remote monitoring location.

### BACKGROUND OF THE INVENTION

1. Field of the Invention

The present invention relates to a security system, in particular, the present invention relates to a monitoring method for a security system.

2. Description of Prior Art

As the social structure and values change, crime rate has being increasing in recent years and securities issues are getting more attentions from the general public. As a result, people concern more and more about the securities issues in order to protect security of one's own and the properties which generate stronger demands towards security systems.

Typically, security systems are installed in valuable manufacturing facilities or shops or personal residence of security concerns in order to assure the safety of commodities, properties, individuals and family members. Further, current security systems are mostly linked to security companies in addition to crime prevention. Accordingly, security systems are also used for early detection on unexpected accidents (such as a fire accident). Though, security systems provided by security companies are expensive and heavy financial burdens to users. There are simple and convenient new applications of security systems in the market which are implemented by different types of detectors for monitoring target locations (such as a residence). Such security systems send warning signal to users when the status becomes unusual, whereby the target locations are protected at a certain security level without extra high cost from users.

For example, Taiwan Pat. 588291 discloses a wireless security system. FIG. 1 is an architecture diagram of a prior art wireless security system. As shown in the diagram, the wireless security system comprises a user end 1 and a monitor end 2 which transmits wireless signals to each other via a base station 3. The user end 1 has a detector 11, a host 12 and a wireless transmitter 13. The detector 11 is used for installing on doors, windows and specific regions to detect background changes in detected areas. In addition, when background change value is detected, the background change value is transmitted to the host 12. Thus, the host 12 generates a signal according to the background change value (not shown). The signal is wireless transmitted to the base station 3 via the wireless transmitter 13. The monitor end 2 has a wireless receiver 21 and a signal processing device 22. The wireless receiver 21 receives the signal sent by the user end 1 via the base station 3, and transmits the signal to the signal processing device 22 for further processing. Thus, user act on the result generated from signal processing by the signal processing device 22.

Nonetheless, the above mentioned security system is an alarming system for one way signal transmission. Signals are generated and sent to monitor end 2 when the detector 11 detects background change values. Further, the user end 1 determines on the situations occurred based on received signals, and is not allowed to receive further information, such as sound or films in the above mentioned security system. As a result, there are improved security systems introduced later to use cameras in security systems. The cameras are installed in the monitored locations and connected to the Internet. The cameras are controlled via the Internet for receiving pictures or films recorded by the cameras.

Nonetheless, the use of Internet involves with complicated setup operations and it is required to install Internet Servers for transmitting messages, pictures or images. Otherwise, users have to pay rentals and maintenance costs for renting third party Internet Servers which are substantial amount of costs to users.

In view of this, the inventor conducted researches and developed a security system implemented with a smart communication device. With the smart communication device, users are allowed to transmit text messages, pictures and films without complicated installing procedures and additional Internet Servers previously required for data transmission.

### SUMMARY OF THE INVENTION

The objective of the invention is to provide a monitoring method for a security system, whereby a user is informed of the status occurred in a remote monitoring location by transmitting messages via general messaging services with a communication device.

In order to achieve the above objective, the present invention provides a security system which comprises a remote communication device, a local communication device, a main controller and a main sensor or a plurality of main sensors. Each main sensor detects the status occurred in a monitoring location and sends sending an output signal to the main controller when the sensor is triggered. The main controller collects output signals sent by each main sensor, and transmits output signals to the local communication device. The local communication device and remote communication device establish a link via a communication connection to transform the received output signals into a warning message to return to the remote communication device.

Another objective of the present invention is to provide a monitoring method for a security system for remotely monitoring films recorded in a monitoring location by transmitting films of the monitoring location via sending messages and dialing out video phone calls.

In order to achieve the above objective, a remote communication device of the present invention sends an instruction message and a local communication device receives the instruction message. Next, the local communication device analyzes the instruction message to extract an operation instruction. If the operation instruction is a monitor instruction, the local communication device starts a film retrieve device according to the operation instruction for recording films in the monitoring location. Lastly, the local communication device dials out a video phone call to the remote communication device based on the recorded films.

The other objective of the present invention is to provide a monitoring method for a security system for remotely controlling ON, OFF status or the status switching of each switch device in a monitoring location by sending a message.

In order to achieve the above objective, the present invention a remote communication device sends an instruction message, and a local communication device receives the instruction message. Next, the local communication device analyzes the instruction message to extract an operation instruction. If the operation instruction is a control instruction, the local communication device controls ON, OFF status or the status switching of a switch device or a plurality of switch devices installed in the monitoring location according to the operation instruction.

Compare to prior art, the advantages provided by the present invention are, a user remotely controls each switch device installed in a monitoring location by sending an instruction message. Further, a sensor or a plurality of main sensors installed in the monitoring location sends or send warning message to a local communication device when the sensor or sensors are triggered. The local communication device returns a text message via Short Message Service (SMS), returns pictures via Multimedia Message Service (MMS), or returns real-time recording films via dialing out a video phone call. Thus, user is allowed to remotely monitor the status occurred in the monitoring location with various methods and precisely and immediately acts on any accident happened in the monitoring location.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an architecture diagram of a prior art wireless security system;

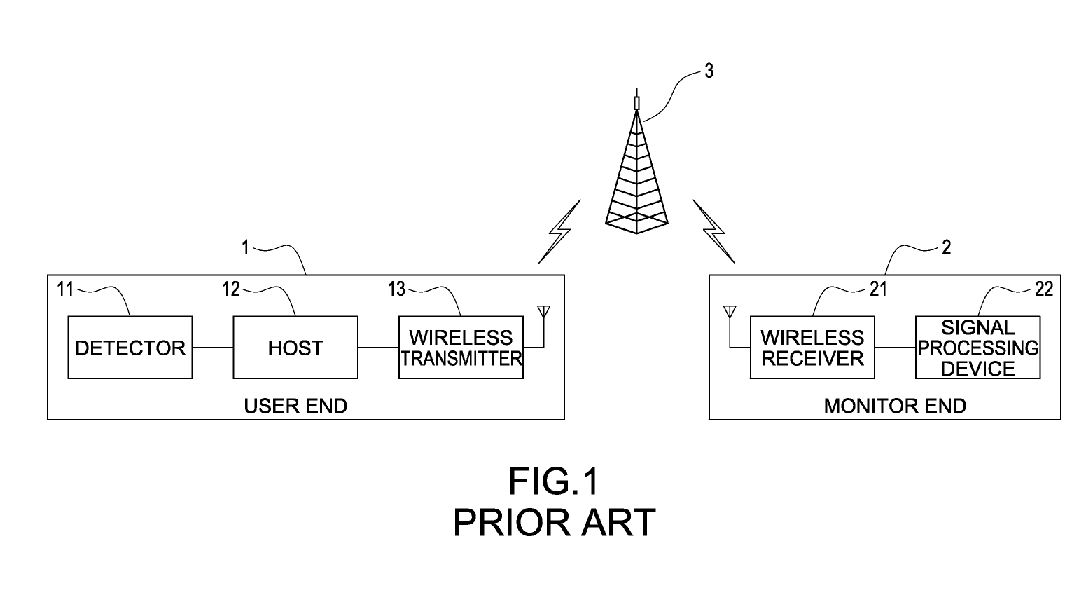

FIG. 2 is a system architecture diagram of a preferred embodiment according to the present invention;

FIG. 3 is a flow chart of a preferred embodiment according to the present invention;

FIG. 4 is a flow chart of another preferred embodiment according to the present invention; and

FIG. 5 is a flow chart of the other preferred embodiment according to the present invention.

### DETAILED DESCRIPTION OF THE INVENTION

In cooperation with attached drawings, the technical contents and detailed description of the present invention are described thereinafter according to preferred embodiments, being not used to limit its executing scope. Any equivalent variation and modification made according to appended claims is all covered by the claims claimed by the present invention.

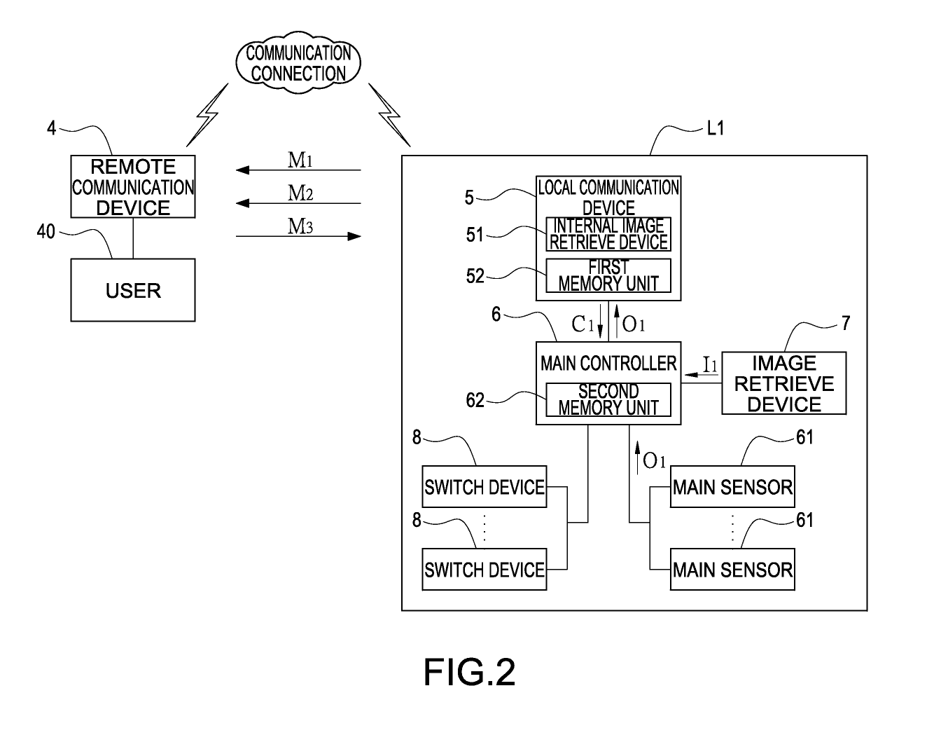

Firstly, FIG. 2 is a system architecture diagram of a preferred embodiment according to the present invention. The security system of the present invention has a remote communication device 4, a local communication device 5, a main controller 6 and a sensor or a plurality of main sensors 61, wherein the local communication device 5, the main controller 6 and the sensor or the plurality of main sensors 61 are installed in a monitoring location L1, and the local communication device 5 and the remote communication device 4 are linked via a communication connection. The sensor or the plurality of main sensors 61 are electrically coupled to the main controller 6, and the main controller 6 is electrically coupled to the local communication device 5. The sensor or the plurality of main sensors 61 are used for detecting the status of the monitoring location L1. The main controller 6 collects detected result of each main sensor 61, and transmitting the detected result to the local communication device 5. Thus, the local communication device 5 returns a text warning message M1 to the remote communication device 4 via Short Message Service (SMS) to keep a user 40 informed of the status occurring in a remote monitoring location L1.

The security system of the present invention can further comprises a film retrieve device 7 installed in the monitoring location L1. The film retrieve device 7 is electrically coupled to the main controller 6 and used for retrieving films of the monitoring location L1 to send to the local communication device 5. Thus, the local communication device 5 returns a picture warning message M2 to the remote communication device via Multimedia Message Service (MMS) to keep a user 40 informed of the status occurred in a remote monitoring location L1 with the picture. Further, the local communication device 5 can have an internal film retrieve device 51, which is a digital camera installed by default in the local communication device 5. Thus, films of the monitoring location L1 are retrieved via the internal film retrieve device 51 for generating the picture warning message M2. Nonetheless, the above descriptions are preferred embodiments of the present invention and the scope of the invention is not limited thereto.

The security system of the present invention can further comprise a plurality of switch devices 8 installed in the monitoring location L1. Each switch device 8 is electrically coupled to the main controller 6. A switch device 8 can be a switch of an electronic device such as a lighting device or a relay. The operations of a switch device 8 comprise turning ON, turning OFF and/or multi-switching mode and are not limited to the above. The remote communication device 4 edits and transmits an instruction message M3 to the local communication device 5. Thus, the main controller 6 controls ON, OFF status or the status switching of each switch device according to the content of the instruction message M3. For example, when the main sensor 61 detects that the monitoring location L1 is dark, the local communication device 5 returns the text warning message M1 to the user 40 to inform the user 40 of the status, the user 40 edits and transmits the instruction message M3 for controlling the switch device 8 of a lighting device in the monitoring location L1 to switch to the ON status.

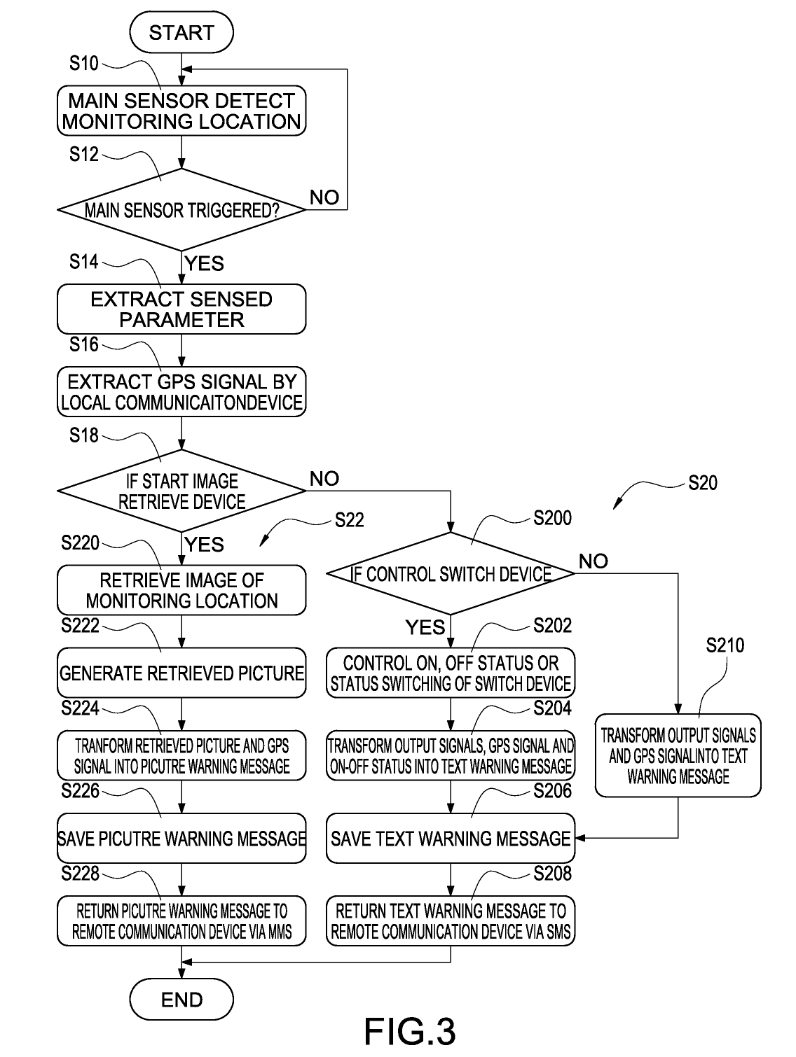

Next, FIG. 3 is a flow chart of a preferred embodiment according to the present invention. Firstly, the sensor or the plurality of main sensors 61 continues or continue to detect the monitoring location L1 (step S10) and determine if each main sensor 61 is triggered by detecting unusual changes in the background (step S12). Each main sensor 61 can be for example a magnetism reed sensor, a smoke sensor, a temperature sensor, a carbon monoxide concentration sensor and a carbon dioxide concentration sensor used for detecting if a fire accident occurs.

Following the step S12, if each main sensor 61 is not triggered, the flow returns to the step S10 to continue to detect. If each main sensor 61 is triggered, each main sensor 61 extracts sensed parameters from detected data to generate an output signal O1 (step S14). Next, the main controller 6 collects the output signals O1 sent respectively by each main sensor 61, and transmits the output signals O1 to the local communication device 5. At the same time, if a Global Positioning System (GPS) function is installed in the local communication device 5, the local communication device 5 can further extract a GPS signal (step S16). For example, if the monitoring location L1 is a car, when each main sensor 61 detects unusual changes in the background, the local communication device 5 provides a GPS signal to the remote communication device 4. Thus, when the car is stolen or towed, the user 4 is informed of the real-time location of the car according to the GPS signal.

Next, the main controller 6 or the local communication device 5 determines to start the film retrieve device 7 or not (step S18). If not, execute step S20 to return the text warning message M1 to the remote communication device 4. If yes, execute step S22 to return the picture warning message M2 to the remote communication device 4. The step S20 further comprises sub-steps S200˜S208, and the step S22 further comprises sub-steps S220˜S226 detailed in the following.

As mentioned above, if the determination result at the step S18 is no, the main controller 6 firstly determines to perform controlling on each switch device 8 or not (step S200). If yes, the main controller 6 controls the ON, OFF status or the status switching of each switch device 8 (step S202). Next, the local communication device 5 transforms the output signals O1, the GPS signal and the ON-OFF status of each switch device 8 into the text warning message M1 (step S204). Optionally, the text warning message M1 is saved in a first memory unit 52 in the local communication device 5, or a second memory unit 62 in the main controller 6 (i.e. the first memory unit 52 and the second memory unit 62 shown in FIG. 2) (step S206). Lastly, the local communication device 5 returns the text warning message M1 to the remote communication device 4 via SMS (step S208).

If the determination result at the step S200 is no, the step S202 is not executed and the local communication device 5 directly transforms the output signals O1 and the GPS signal into the text warning message M1 (step S210). Next, execute the step S206 to save the text warning message M1 in the first memory unit 52 and/or the second memory unit 62, and execute the step S208 to returns the text warning message M1 to the remote communication device 4 via SMS.

It should be noted that the GPS signal is optional in the embodiment. For example, if the local communication device 5 does not have a GPS function, the GPS signal does not exist and cannot be extracted in the following step. Further, if the monitoring location L1 is a fixed location, the user 40 may configure to cancel the GPS function.

As mentioned above, if the determination result at the step S18 is yes, the film retrieve device 7 or the internal film retrieve device 51 are started to retrieve films of the monitoring location L1 (step S220) to generate a retrieved picture I1 (step S222). Next, the local communication device 5 transforms the retrieved picture I1 and the GPS signal into the picture warning message M2 (step S224). The picture warning message M2 is saved in the first memory unit 52 and/or the second memory unit 62 (step S226). Lately, the picture warning message M2 is returned to the remote communication device 4 via MMS (step S228).

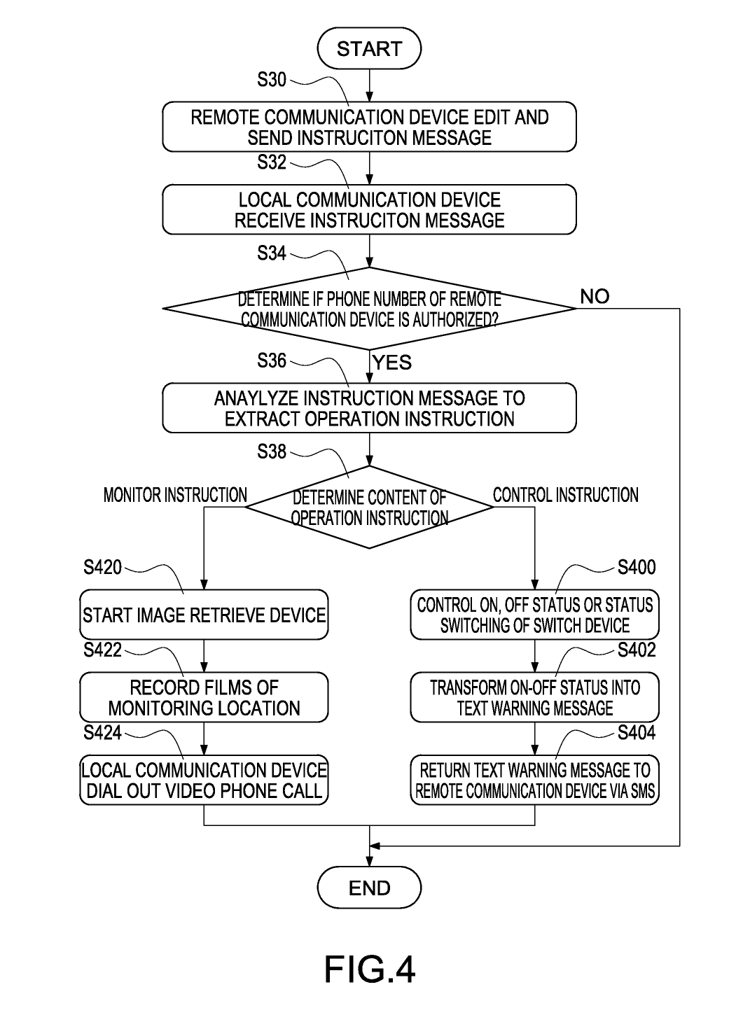

Next, FIG. 4 is a flow chart of another preferred embodiment according to the present invention. In the above embodiments, the local communication device 5 collects the status of the monitoring location L1, and automatically returns the status of the monitoring location L1 to the remote communication device 4. However, the user 40 can also use the remote communication device 4 to make a monitor or control request the device in the monitoring location L1 with steps detailed in the following.

Firstly, the user 40 uses the remote communication device 4 to edit and send the instruction message M3 according to the demands (step S30). Next, the local communication device 5 receives the instruction message M3 via SMS (step S32). After the instruction message M3 is received, the local communication device 5 determines phone number of the remote communication device 4 is authorized by the local communication device 5 (step S34). If not, the local communication device 5 does not execute any steps. If phone number of the remote communication device 4 is authorized by the local communication device 5, the local communication device 5 analyzes the instruction message M3 to extract an operation instruction C1 (step S36). Next, the local communication device 5 categorizes the content of the operation instruction C1 (step S38), and the control operation C1 is categorized as a controlling instruction or a monitor instruction according to the content of the instruction message M3 edited by the user 40.

If the operation instruction C1 is a controlling instruction, the main controller 6 controls the ON, OFF status or the status switching of each corresponding switch device 8 according to the operation instruction C1 (step S400). Next, the local communication device 5 receives the ON-OFF status of each switch device 8, and transforms the ON-OFF status of each switch device 8 into the text warning message M1 (step S402). Lastly, the text warning message M1 is returned to the remote communication device 4 via SMS.

If the operation instruction C1 is a monitor instruction, the main controller 6 or the local communication device 5 starts the film retrieve device 7 or the internal film retrieve device 51 according to the operation instruction C1 (step S420). The films of the monitoring location L1 are recorded via the film retrieve device 7 or the internal film retrieve device 51 (step S422). The local communication device 5 dials out a video phone call to the remote communication device 4 (step S424). Accordingly, the user 40 is allowed to monitor the films of the monitoring location L1 recorded by the film retrieve device 7 or the internal film retrieve device 51 with the remote communication device 4.

In the above embodiments, the remote communication device 4 sends the instruction message M3. The local communication device 5 analyzes and receives the operation instruction C1 and then executes operation steps according to the operation instruction C1. However, if the user 40 is located in the monitoring location L1, the user 40 may directly use the local communication device 5 and control or set up setup of each device in the monitoring location L1 with steps detailed in the following.

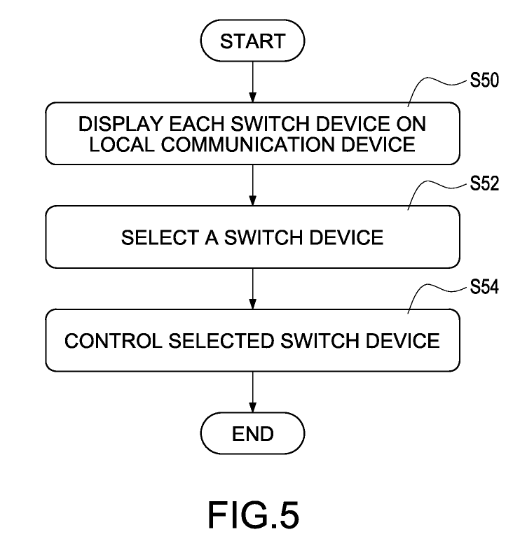

FIG. 5 is a flow chart of the other preferred embodiment according to the present invention. Firstly, all connected switch devices 8 are displayed on the display screen (not shown) of the local communication device 5 (step S50). Next, the switch device 8 is selected to control among connected switch device 8 displayed on the local communication device (step S52). For example, a user clicks on touch screen display screen of the local communication device 5 or presses the button on the local communication device 5 via controlling a cursor, finger or stylus. Lastly, the selected switch device 8 is controlled (step S54). The control operations include controlling the ON, OFF status or the status switching of the switch device 8.

In addition, the user 40 further sets up parameters of the main controller 6 and performs operations of adding, deleting and setting up each main sensor 61 connected to the main controller 6 via the local communication device 5. The user 40 adds required devices to the security system depending on the user demands in order to perform particular purposes. Or, the user 40 deletes devices not in use to reduce the cost resulted from operations of the security system.

As the skilled person will appreciate, various changes and modifications can be made to the described embodiments. It is intended to include all such variations, modifications and equivalents which fall within the scope of the invention, as defined in the accompanying claims.

What is claimed is:

1. A monitoring method for a security system, the security system having a remote communication device, a local communication device, a main controller and a sensor or a plurality of main sensors, the local communication device, the main controller and each main sensor being installed within a monitoring location, and the local communication device and the remote communication device being linked via a communication connection, the monitoring method comprising steps:
a) triggering each main sensor;
b) retrieving sensed parameters at each main sensor for sending an output signal;
c) collecting the output signal sent by each main sensor at the main controller and transmitting the output signals to the local communication device; and
d) transforming the received output signals into a warning message, and returning the warning message to the remote communication device at the local communication device.

2. The monitoring method of claim 1, wherein the method further comprises a step e1: providing a first memory unit at the local communication device for saving the warning message.

3. The monitoring method of claim 1, wherein the method further comprises a step e2: providing a second memory unit at the main controller for saving the warning message.

4. The monitoring method of claim 1, wherein the local communication device is installed with a Global Positioning System (GPS) function, and a step f following the step a further comprises a step: retrieving a GPS signal at the local communication device.

5. The monitoring method of claim 4, wherein at the step d, the local communication device transforms the output signals and the GPS signal into a text warning message, and returns the text warning message to the remote communication device via short messaging service (SMS).

6. The monitoring method of claim 4, wherein the security system further comprises a plurality of switch devices installed in the monitoring location, and the method further comprises a step c1 following the step c: controlling the ON, OFF status or the status switching of each switch device according to the output signal sent by each main sensor at the main controller.

7. The monitoring method of claim 6, wherein at the step d, the local communication device transforms the output signals, the GPS signal and ON-OFF status of each switch device into the text warning message, and returns the text warning message to the remote communication device via SMS.

8. The monitoring method of claim 4, wherein the security system further comprises a film retrieve device, and the method further comprises steps following the step a:
a1) starting the film retrieve device following the step a;
a2) retrieving films at the monitoring location at the film retrieve device to generate a retrieved picture;
a3) transforming the retrieved picture and the GPS signal into a picture warning message, and returning the picture warning message to the remote communication device via multimedia messaging service (MMS) at the local communication device.

9. The monitoring method of claim 1, wherein the method further comprising steps:
g) providing an instruction message at the local communication device;
h) analyzing the instruction message to extract an operation instruction at the local communication device;
i) providing a film retrieve device at the security system, if the operation instruction being a monitor instruction, the main controller starting the film retrieve device to record films of the monitoring location according to the operation instruction;
j) providing a plurality of switch devices at the security system, if the operation instruction being a controlling instruction, the main controller controlling the ON, OFF status or the status switching of each switch device according to the operation instruction.

10. The monitoring method of claim 9, wherein the method further comprises a step g1 following the step g: determining if the phone number of the remote communication device is authorized by the local communication device.

11. The monitoring method of claim 9, wherein the method further comprises a step i1 following the step i: dialing out a video phone call to the remote communication device at the local communication device.

12. The monitoring method of claim 9, wherein the method further comprises following the step j:
j1) transforming the ON-OFF status of each switch device into a text warning message at the local communication device;
j2) returning the text warning message to the remote communication device via SMS at the local communication device.
